(19) United States
(12) Patent Application Publication
(10) Pub. No.: US 2010/0219246 A1
(43) Pub. Date: Sep. 2, 2010

(54) SIGNAL PROCESSING FOR LIGHT BEAM SENSING

(75) Inventor: Norio Nakamura, Warabi (JP)

Correspondence Address: Kaplan Gilman & Pergament LLP, 1480 Route 9 North, Woodbridge, NJ, 07095, US

(73) Assignees: Optoelectronics Co. Ltd., Warabi (JP); Opticon, Inc., Orangeburg, NY (US)

(21) Appl. No.: 12/759,279

(22) Filed: Apr. 13, 2010

Related U.S. Application Data
(63) Continuation of application No. PCT/US2007/084071, filed on Nov. 8, 2007.

(51) Int. Cl. G06K 7/10

(52) U.S. Cl. 235/454

(57) ABSTRACT

In an optical code sensor of the type in which a signal derived from a light beam encoded with digital data is obtained by extracting transitions, an adjustable bandwidth filter is interposed before processing to extract the data. The distance of the optical code is detected, and the filter bandwidth is increased in relationship to the distance of the bar code. Preferably, the input signal to the filter is applied to a shift register and the output at each stage of the register is multiplied by a predetermined coefficient calculated to achieve a particular waveshape, preferably a Gaussian waveshape, via the entire set of coefficients. The register stage outputs, multiplied by the coefficients are then added together to produce a filtered output signal applied to the processor.

This application is a continuation of International Application No. PCT/US07/084071, filed Nov. 8, 2007, which designated the United States of America and was published in English on May 14, 2009 under Publication No. WO 2009/061319. This International Application is hereby incorporated by reference in its entirety.

### BACKGROUND ART

The present invention relates generally to signal processing and, more particularly, concerns a method and filter for processing a light beam that has been encoded with data so as to improve the signal-to-noise ratio of the signal that is extracted after the light beam is processed.

Data communication utilizing light as a transmission medium is gaining widespread acceptance. One application in which data encoded light has long been in use is optical code scanners, such as barcode scanners.

Today, barcode scanners typically use laser light to illuminate a remote barcode. FIG. 1 is a schematic block diagram illustrating the operation of a typical barcode scanner. Laser light L reflected from the barcode is modulated by the dark and light portions of the barcode and is sensed by a photodiode PD, which produces a current representing the modulated light. That current signal is applied to a preamplifier 10, which converts it to a voltage signal. The voltage signal is provided to a differentiation circuit 12, which generates pulses corresponding to each transition in the preamplifier output, and an automatic gain control (AGC) circuit 14 maintains the signal amplitude relatively constant, regardless of variations in the received signal. The gain controlled signal is then applied to a low pass filter (LPF) 16, which removes extraneous high-frequency variations, and then to an analog-to-digital converter (ADC) 18. The resulting digital signal is then applied to a processor 20, which decodes and extracts the barcode from the signal.

In extracting the barcode, a problem arises, in that the frequency spectrum of the signal applied to the filter changes in relationship to the distance of the bar code from the scanner, limiting the effectiveness of the filter. When the processor has been unable to recognize the bar code correctly, it has been the practice in the prior art for the processor to adjust the filter bandwidth stepwise in a kind of hunting process to improve recognition. However, this is a slow and cumbersome process, making efficient and accurate reading of barcode difficult, if not impossible.

### DISCLOSURE OF INVENTION

In accordance with one aspect of the present invention, in an optical code sensor of the type described, an adjustable bandwidth filter replaces the low pass filter. The distance of the optical code is detected, and the filter bandwidth is increased in relationship to the distance of the bar code. Preferably, the input signal to the filter is applied to a shift register and the output at each stage of the register is multiplied by a predetermined coefficient calculated to achieve a particular waveshape, preferably a Gaussian waveshape, via the entire set of coefficients. The register stage outputs, multiplied by the coefficients are then added together to produce a filtered output signal applied to the processor.

Preferably, in order to achieve bandwidth adjustment, the clock rate of the register is adjusted. Specifically, the detected bar code distance is used to control the frequency of a voltage controlled oscillator (VCO), which serves as the clock for the shift register.

### BRIEF DESCRIPTION OF DRAWINGS

The foregoing brief description and further object features, and advantages of the present invention will be understood more completely from the following detailed description of a presciently preferred, but nonetheless illustrative, embodiment in accordance with the present convention, with a reference being had to the accompanying drawings, in which:

FIG. 1 is a schematic block diagram illustrating the operation of a typical barcode scanner;

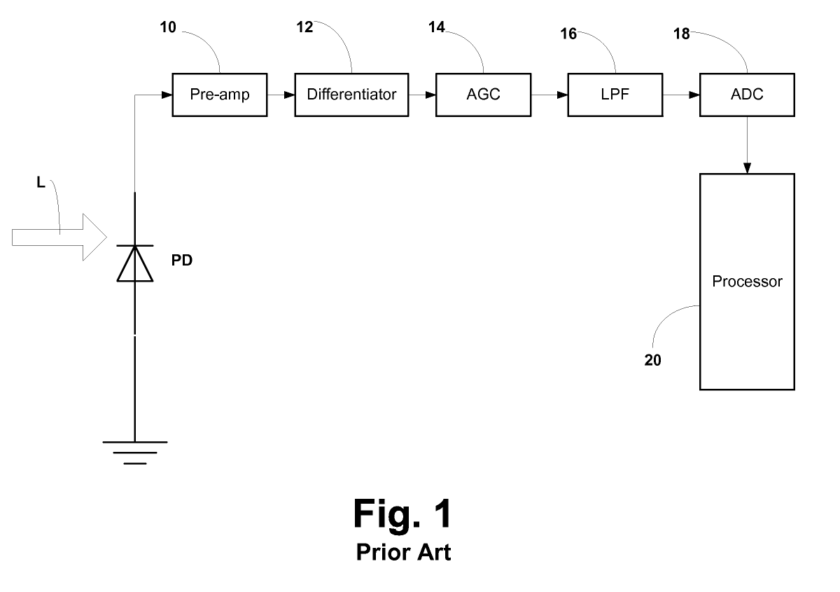

FIG. 2 is a schematic block diagram illustrating the operation of a barcode scanner embodying the present invention;

FIG. 3 shows Gaussian waveforms representing filters with different standard deviations (bandwidths);

FIG. 4 is a schematic block diagram illustrating a preferred embodiment of a digital filter; and

FIG. 5 presents waveforms useful in further understanding the operation of digital filter.

### DETAILED DESCRIPTION OF THE PREFERRED EMBODIMENT

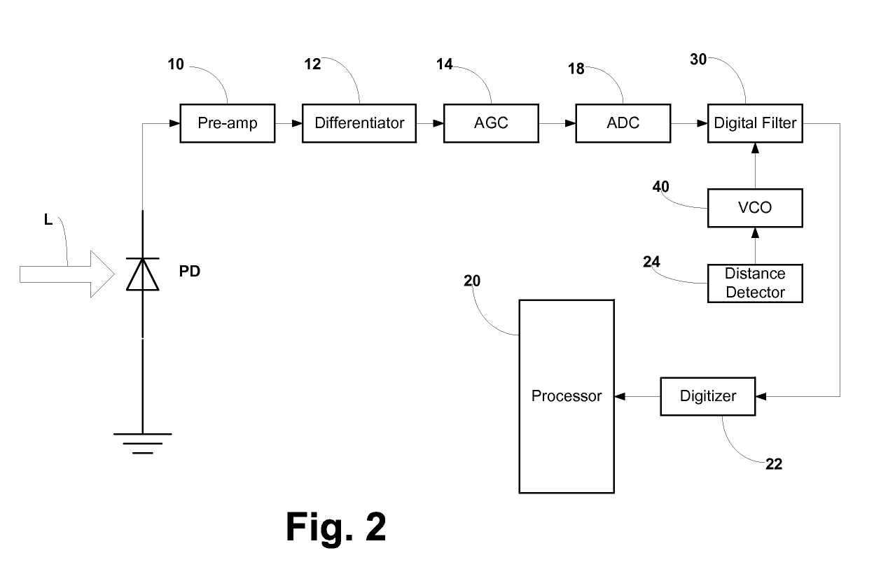

Turning now to the details of the drawings, FIG. 2 is a schematic block diagram illustrating the operation of a barcode scanner embodying the present invention. Laser light L reflected from the barcode is modulated by the dark and light portions of the barcode and is sensed by a Photodiode PD, which produces the current representing the modulated light. That current signal is applied to a preamplifier 10, which converts it to a voltage signal. The voltage signal is provided to a differentiation circuit 12, which generates pulses corresponding to each transition in the preamplifier output, and an automatic gain control (AGC) circuit 14 maintains the signal amplitude relatively constant, regardless of variations in the received signal. The gain controlled signal is then applied to analog-to-digital converter (ADC) 18. The resulting digital signal is then applied through a digital filter 30 and a digitizer 22 to a processor 20, which decodes or extracts the barcode from the signal.

Broadly, digital filter 30 is a variable filter, of which the bandwidth may be controlled. A distance detector senses the distance of the barcode, and the bandwidth of digital filter 30 is controlled in direct relationship to that distance.

Pulses received by digital filter 30 have an approximately Gaussian waveshape. Those skilled in communication theory will understand that the best signal-to-noise response will be obtained with a matched filter. That is, one which conforms to the frequency spectrum and time domain characteristic of the incoming signal. Therefore, in the preferred embodiment, filter 30 was designed to have a Gaussian time domain response.

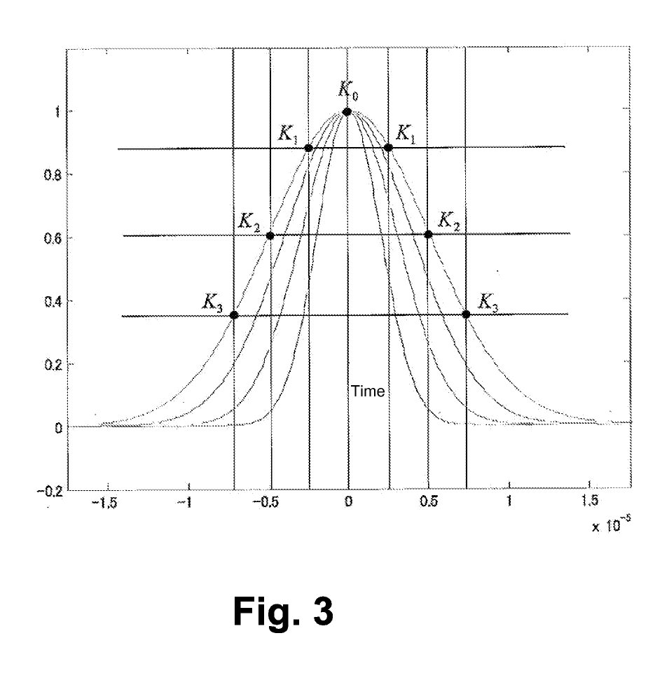

FIG. 3 shows Gaussian waveforms representing filters with different standard deviations (bandwidths). On one of the waveforms, points are marked K₀, K₁, . . . K₃. These represent coefficient values that will be used for a purpose to be described below, in order to characterize the Gaussian or normal curve.

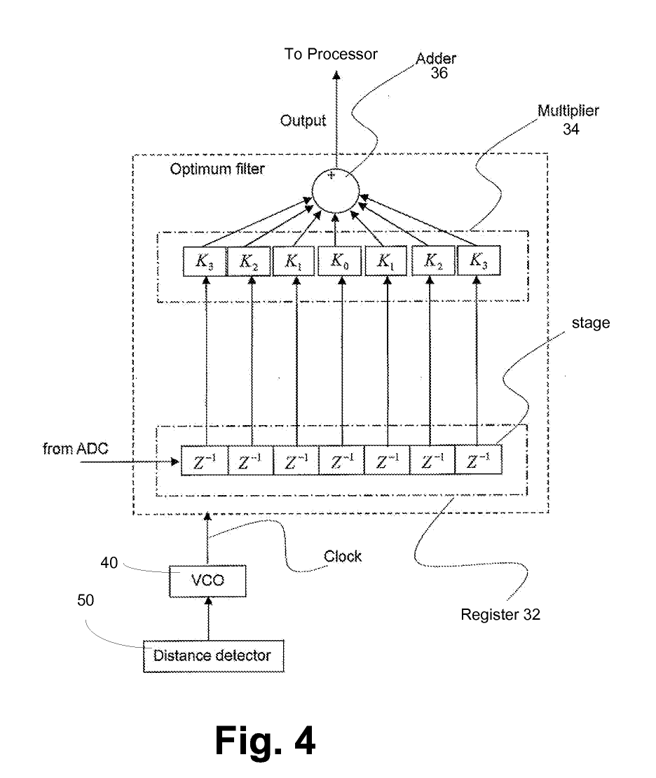

FIG. 4 is a schematic block diagram illustrating a preferred embodiment of filter 30. The signal from (ADC) 18 is applied as an input to a shift register 32, in which the outputs at each stage are tapped and, in multiplier of 34, multiplied by a respective 1 of the coefficients K₀, K₁, . . . K₃. The shift register outputs, so multiplied, are then summed in adder 36 to produce an output signal which is applied to the processor 20. This operation is performed continuously, in real time, to, effectively, convolve the input signal from the ADC 18 with the characteristic of the digital filter 30. Those skilled in the art will appreciate that this is equivalent to performing a multiplication between the input signal representation and the filter representation in the frequency domain. Thus, this is basically the equivalent of treating the filter characteristic as a transfer function and obtaining the output signal resulting from the filter operating on the input signal.

A voltage controlled oscillator (VCO) provides the clock signal for shift register 32. The voltage controlled oscillator is driven by a distance detector 50. The detector 50 produces a voltage signal which increases with the distance of the bar code and causes the output frequency of the VCO 40 to increase accordingly. This, effectively, causes the bandwidth of filter 30 to increase, while still maintaining the same characteristic shape.

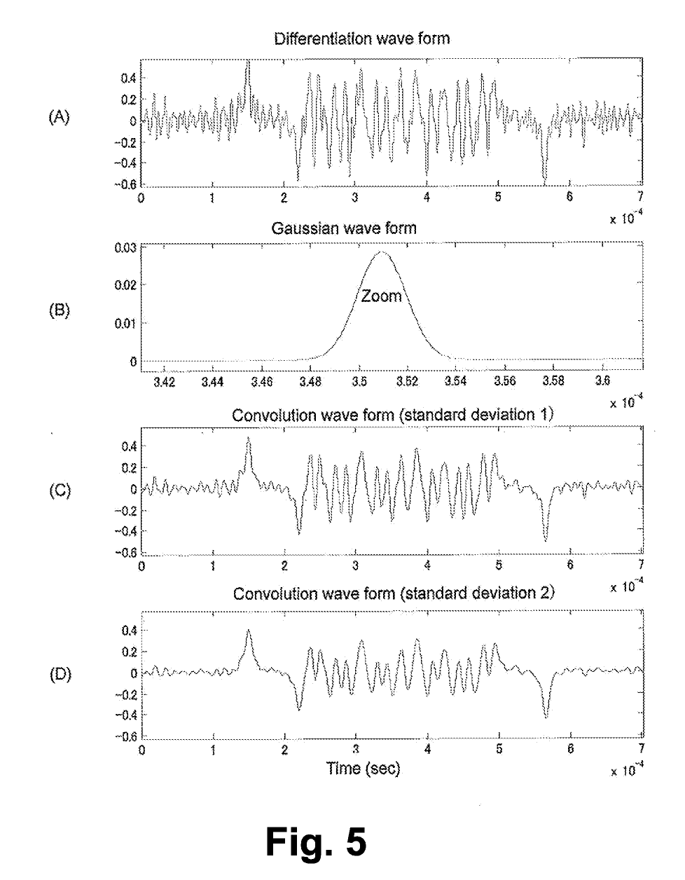

FIG. 5 presents waveforms useful in further understanding the operation of digital filter 30. Waveform A represents the input waveform to the filter. Waveform B represents the Gaussian characteristic of the filter 30, and waveform C and D represent convolutions between waveforms A and B when different frequencies are applied by VCO 40. In this instance, the frequency was increased from waveform C to waveform D, resulting in an improvement in signal-to-noise. It should be appreciated that waveforms C and D correspond to differentiated versions of the signal received from preamplifier 10. A signal corresponding to the detected bar code would then be obtained by integrating these waveforms.

Although a preferred embodiment of the invention has been disclosed for illustrative purposes, those skilled in the art will appreciate that many additions, modifications, and substitutions are possible without the departing from the scope and spirit of the invention as defined by the accompanying claims.

What is claimed:

1. A method for improving the signal-to-noise ration in a signal derived from a light beam encoded with digital data by extracting transitions thereof, comprising the steps of, prior to processing the signal to extract the data, applying it to a filter in which the bandwidth is controlled in direct relation to the distance of the source of the light beam to a target to be read.

2. The method of claim 1 wherein the filter is a low pass filter and its bandwidth is defined by a cutoff frequency.

3. The method of claim 1 wherein the filter has a waveshape which is matched to a pulse waveshape of said signal.

4. The method of claim 1 wherein the light beam is a laser beam.

5. The method of claim 1 wherein the light beam is a laser beam reflected from an optical code.

6. The method of claim 1 wherein the filter is a digital filter, the bandwidth of which is controlled by the frequency of a variable oscillator, said method further comprising the steps of sensing the distance of the source of the light beam and adjusting the frequency of the oscillator in direct relation thereto.

7. The method of claim 6 wherein the filter has a waveshape which is matched to a pulse waveshape of said signal.

8. The method of claim 6 wherein said filter comprises a shift register which receives the signal and is shifted by the variable oscillator, the register having stages at which outputs are added with predefined weighting to produce an output of the filter which is to be subjected to processing to extract the data.

9. The method of claim 6 performed with the use of a distance detector which senses the distance and controls the oscillator frequency accordingly.

10. The method of claim 9 wherein the oscillator is a voltage controlled oscillator responsive to a voltage out put of the distance detector.

11. A filter for improving the signal-to-noise ration in a signal derived from a light beam encoded with digital date by extracting transitions thereof, the signal to be applied to a processor to extract the digital data, the filter to be disposed ahead of the processor, comprising:
a filter portion having a control input controlling the bandwidth of the in direct relation to the value of the a control signal applied thereto; and
a distance sensing portion for determining the distance of a source of said light beam and producing a signal directly related to said distance, the signal being applied to the control input.

12. The filter of claim 11 wherein the filter portion is a low pass filter and its bandwidth is defined by a cutoff frequency.

13. The filter of claim 11 wherein the filter portion has a waveshape which is matched to a pulse waveshape of said signal.

14. The filter of claim 11 wherein the light beam is a laser beam.

15. The filter of claim 11 wherein the light beam is a laser beam reflected from an optical code.

16. The filter of claim 1 wherein the filter portion is a digital filter having a bandwidth control input and responsive to a the frequency of a signal applied thereto to adjust the bandwidth in direct relation to said frequency, further comprising a variable oscillator connected to the control input, and a distance sensor sensing the distance of the source of the light beam and adjusting the frequency of the oscillator in direct relation thereto.

17. The filter of claim 11 wherein the filter portion has a waveshape which is matched to a pulse waveshape of said signal.

18. The filter of claim 16 wherein said filter portion comprises a shift register which receives the signal and is shifted by the variable oscillator, further comprising a weighter applying a predefined weighting to each register out put stage and an adder combining the weighted outputs to produce an output of the filter which is to be subjected to processing to extract the data.

19. The filter of claim 18 wherein the oscillator is a voltage controlled oscillator responsive to the distance sensor.

20. The filter of claim 18 wherein the predefined weighting is related to the pulse waveshape of said signal.
